(19) United States
(12) Patent Application Publication
(10) Pub. No.: US 2012/0038673 A1
(43) Pub. Date: Feb. 16, 2012

(54) MAGNETIC RESONANCE IMAGING APPARATUS AND METHOD FOR DISPLAYING RUNNING DIRECTION OF FIBROUS TISSUE

(75) Inventor: Yoshihiro Iwata, Tokyo (JP)

(73) Assignee: HITACHI MEDICAL CORPORATION, Tokyo (JP)

(21) Appl. No.: 13/265,173

(22) PCT Filed: Apr. 13, 2010
(86) PCT No.: PCT/JP2010/056551

§ 371 Date: Oct. 19, 2011

(30) Foreign Application Priority Data
Apr. 22, 2009 (JP) 2009-103540

(51) Int. Cl. G09G 5/00; G06T 11/20

(52) U.S. Cl. 345/649; 345/441

(57) ABSTRACT

In order to be able to easily obtain a color FA image in which the same fibrous tissue has the same color display even if images are captured in a state in which the position of an object relative to an MRI apparatus is different, a diffusion tensor is configured using plural sets of the diffusion-weighted image data acquired by capturing images of a site including the fibrous tissue of the object, an eigenvector is obtained from the diffusion tensor, the eigenvector represented by a predetermined first coordinate system is converted into a second coordinate system, and an image representing the running direction of the fibrous tissue is obtained on the basis of the components of the eigenvector represented by the second coordinate system.

The second coordinate system is obtained preferably on the basis of the scanned cross-section, or on the basis of the eigenvector for the specified pixel in the image obtained by capturing images of the cross-section, or in accordance with the rotation angle of the coordinate system set by a coordinate system rotation UI.

### FIELD OF THE INVENTION

The present invention relates to a magnetic resonance imaging apparatus (hereinafter referred to as an MRI apparatus), particularly to a technique for displaying running direction of fibrous tissue.

### DESCRIPTION OF RELATED ART

An MRI apparatus measures NMR signals produced from atomic nuclei forming biological tissue of an object, especially a human body, and generates a 2-dimensional or 3-dimensional image showing the shape or function of a region such as a head region, abdominal region or extremities. In the imaging, the NMR signals are provided with different phase encodes depending on the gradient magnetic field, performed with frequency encodes, and measured as time-series data. The measured NMR signals are reconstructed as an image while being executed with 2-dimensional or 3-dimensional Fourier transform.

In this MRI apparatus, diffusion-weighted imaging (DWI) is executed. In DWI, a pair of intense gradient magnetic fields referred to as MPG (Motion Probing Gradient) pulses are applied to an object to be examined so as to disarray phase of the spin which moves in the tissue of the object so as to image the motion thereof in the molecular level.

Furthermore, a Fractional Anistropy (FA) image can be calculated by imaging a plurality of DWI images using the DWI technique while differentiating application direction of MPG pulses and calculating diffusion tensor (3×3 matrix) that represents the direction and degree of the water molecule diffusion using the DWI image data thereby obtaining the eigenvalue from the calculated diffusion tensor (hereinafter referred to as the diffusion tensor method). An FA image represents anisotropic nature of diffusion movement in water molecules, wherein the part having the molecule that diffuses anisotropically (diffuses in a specified direction) is represented as a high signal and the part having the molecule that diffuses isotropically (diffuses omnidirectionally and averagely) is represented as a low signal. A suitable example of an FA image is the configuration of fibrous tissue which is extended in one direction like a nerve tissue.

Further, colored FA images have been used since it is difficult to sufficiently acknowledge which direction fibrous tissue is extending with such a simple FA image. In order to create a colored FA image, three eigenvectors are calculated from the diffusion tensor in a 3-dimensional space, the direction of the eigenvector corresponding to the maximum eigenvalue (principal value) from among the three eigenvectors is set(principal-axis direction) as the direction of the fibrous tissue (hereinafter referred to as the fiber tracking method), the colors of red, blue and green are respectively allocated in accordance with the 3-dimensional components (x, y and z) of the principal vector, and the running direction of the fibrous tissue is displayed with different colors. The above-described display method of color FA images is disclosed, for example in non-patent document 1.

However, since the principal vector which represents the running direction of fibrous tissue is shown on the coordinate system which is fixed to an MRI apparatus (for example, the horizontal direction of the MRI apparatus is represented by an x-axis, the vertical direction is represented by a y-axis and the depth direction is represented by a z-axis: first coordinate system), even in the case that the same object is imaged, the fibrous tissue will be displayed in different colors unless the positions of the object are the same with respect to the MRI apparatus. Therefore, there are times that the same fibrous tissue in a color FA image are displayed in different colors, whereby leading to degradation of diagnostic performance.

Given this factor, the technique disclosed in Patent Document 1 generates colored FA images so that the pixels corresponding to each nerve fiber running along the curved surface including the tract which is extracted in the tracked nerve fiber and the nerve fiber running along the other direction besides the curved surface are displayed in different colors.

### PRIOR ART DOCUMENTS

Patent Document: JP-A-2008-148981

Non-patent Document 1: “Korede Wakaru Kakusan MRI” (Revised Version) by Shigeki Aoki, Osamu Abe and Yoshitaka Masutani

The method disclosed in Patent Document 1 is for applying to 3-dimensional diffusion tensor color map images, not for 2-dimensional color FA images. Also, the method requires 3-dimensional processing for determining the curve surface including the tract to be extracted in the tracked nerve fiber, which complicates the process and is not suitable for applying to reconstruction of 2-dimensional color FA images.

Given this factor, the objective of the present invention is to provide an MRI apparatus considering the above-described problems, capable of easily obtaining color FA images in which the same fibrous tissue is displayed with the same color.

### BRIEF SUMMARY OF THE INVENTION

In order to achieve the above-described objective, the present invention is characterized in obtaining a diffusion tensor using plural sets of diffusion-weighted image data acquired by imaging the region including fibrous tissue of an object, obtaining the eigenvector from the diffusion tensor, converting the eigenvector represented in a predetermined first coordinate system to a second coordinate system, and obtaining an image showing the running direction of fibrous tissue based on the component of the eigenvector represented in the second coordinate system. The second coordinate system is to be based on preferably the scanned cross-section or else the eigenvector with respect to the pixel specified in the image obtained by scanning the cross-section, or according to the rotating angle of the coordinate system set by the coordinate system rotation UI.

In concrete terms, the MRI apparatus of the present invention is characterized in comprising:

an imaging unit configured to apply a diffusion-weighted gradient magnetic field to a region including fibrous tissue of an object so as to acquire plural sets of diffusion-weighted image data with respect to the scanned cross-section including the fibrous tissue; and

a calculation processing unit configured to obtain a diffusion tensor using plural sets of diffusion-weighted image data and calculate the eigenvector represented in a predetermined first coordinate system from the diffusion tensor so as to obtain an image showing the running direction of the fibrous tissue based on the calculated eigenvector,

wherein the calculation processing unit converts the component of eigenvector represented in a predetermined first coordinate system to a second coordinate system and obtain an image showing the running direction of the fibrous tissue of the object based on the component of the eigenvector represented in the second coordinate system.

Also, the method for displaying running direction of fibrous tissue related to the present invention is characterized, in the case of obtaining a diffusion tensor using plural sets of diffusion-weighted image data acquired by imaging the region including fibrous tissue of the object, calculating the eigenvector which is represented in a predetermined first coordinate system from the diffusion tensor and displaying the image showing the running direction of the fibrous tissue based on the eigenvector, includes:

a step of obtaining a second coordinate system;

a step of converting the component of the eigenvector represented in a predetermined first coordinate system to a second coordinate system; and

a step of obtaining an image showing the running direction of the fibrous tissue based on the component of the eigenvector represented in the second coordinate system.

### Effect of the Invention

In accordance with the MRI apparatus and the method for displaying running direction of fibrous tissue of the present invention, it is possible to easily obtain color FA images in which the same fibrous tissue is displayed with the same color even in the case that imaging is executed while an object is disposed at different positions with respect to an MRI apparatus, by indicating the direction of the fibrous tissue in the coordinate system of the cross-section.

### BRIEF DESCRIPTION OF THE DRAWINGS

FIG. 1 is a block diagram showing a general basic configuration in a first embodiment of an MRI apparatus related to the present invention.

FIG. 2 is a view showing the scanned cross-section of an object placed in a static magnetic field of an MRI apparatus, which is related to the first embodiment of the present invention.

FIG. 3 is a flowchart showing the processing flow of the first embodiment related to the present invention.

FIG. 4 is a view showing the case that a desired pixel is specified on the image obtained by imaging a cross-section of the object placed in a static magnetic field of an MRI apparatus, which is related to a second embodiment of the present invention. FIG. 4(a) shows the case of imaging a cross-section of the object placed in a static magnetic field of an MRI apparatus, and FIG. 4(b) shows the case of specifying a desired pixel on the image obtained by imaging the cross-section of (a).

FIG. 5 is a flowchart showing the processing flow of the second embodiment related to the present invention.

FIG. 6 is a view showing the UI for setting the color display reference coordinate system along with the image obtained by scanning a cross-section of the object placed in a static magnetic field of an MRI apparatus, which is related to a third embodiment of the present invention. FIG. 6(a) shows the case of imaging a cross-section of an object placed in a static magnetic field of an MRI apparatus, and FIG. 6(b) shows the UI for setting the color display reference coordinate system.

FIG. 7 is a flowchart showing the processing flow of the third embodiment related to the present invention.

FIG. 8 is a sequence chart showing an example of the pulse sequence for executing the diffusion tensor imaging.

### DETAILED DESCRIPTION OF THE INVENTION

Preferable embodiments of the MRI apparatus related to the present invention will be described below in detail referring to the attached drawings. In the following description, the same function parts are represented by the same reference numerals, and the duplicative description thereof is omitted.

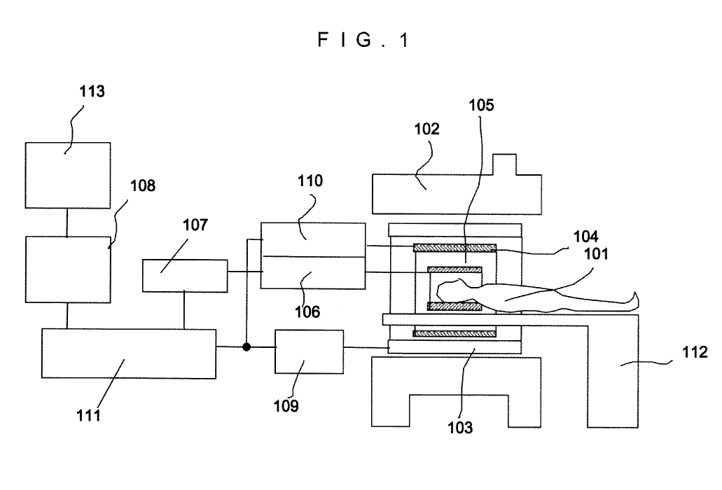

First, the general overview of an example of the MRI apparatus related to the present invention will be described based on FIG. 1. FIG. 1 is a block diagram showing general configuration of the first embodiment related to the MRI apparatus in the present invention. This MRI apparatus obtains an image of an object 101 using NMR phenomenon, and is configured comprising a static magnetic field generating magnet 102, a gradient magnetic field coil 103, a gradient magnetic field source 109, a transmission coil 104, an RF transmission unit 110, a reception coil 105, a signal detection unit 106, a signal processing unit 107, a measurement control unit 111, an overall control unit 108, a display/operation unit 113, and a bed 112 configured to place the object 101 thereon and carry the object in and out of the static magnetic field generating magnet 102, as shown in FIG. 1.

The static magnetic field generating magnet 102 generates a uniform static magnetic field in the direction orthogonal to the body axis of the object 101 if it is of the vertical magnetic field method and in the body-axis direction if it is of the horizontal magnetic field method. The static magnetic field generating source of the permanent magnet method, normal conductive method or superconductive method is disposed around the object 101.

The gradient magnetic field coil 103 is wound in three-axis directions of X, Y and Z forming the coordinate system (coordinate system at rest) of an MRI apparatus, and the respective gradient magnetic field coils are connected to gradient magnetic field sources 109 that drive them while being provided with a current. In concrete terms, the gradient magnetic field sources 109 of the respective gradient magnetic field coils are respectively driven according to the command from the measurement control unit 111 to be described later, so as to provide the current to the respective gradient magnetic field coils. In this manner, gradient magnetic fields Gx, Gy and Gz are generated in the three-axis directions of X, Y and Z. At the time of imaging, a slice gradient magnetic field pulse (Gs) is applied in the direction orthogonal to the slice surface (scanned cross-section) so as to set the slice surface with respect to the object 101, and a phase encode gradient magnetic field pulse (Gp) and a frequency encode gradient magnetic field pulse (Gf) are applied in the remaining two directions that are orthogonal to the set slice surface and orthogonal also to each other, thereby encoding positional information of the respective directions to the echo signal.

The transmission coil 104 irradiates a high-frequency magnetic field pulse (hereinafter referred to as an RF pulse) to the object 101, and is connected to the RF transmission unit 110 by which a high-frequency pulse current is provided. In this manner, a nuclear magnetic field resonance is excited to the atomic nuclei spin of atom elements by which biological tissue of the object 101 are formed. In concrete terms, the RF transmission unit 110 is driven according to the command from the measurement control unit 111 to be described later, so as to amplitude-modulate and amplify a high-frequency pulse. The pulse is provided to the transmission coil 104 which is placed in the vicinity of the object 101 so as to irradiate an RF pulse to the object 101.

The reception coil 105 is connected to the signal detection unit 106, receives the NMR signal (echo signal) which is emitted by the NMR phenomenon of the atomic nuclei spin by which the biological tissue of the object 101 are formed, and transmits the received echo signal to the signal detection unit 106. The signal detection unit 106 executes the detection process of the echo signal received by the reception coil 105. In concrete terms, the responsive echo signal of the object 101 which is excited by the RF pulse irradiated from the transmission coil 104 is received by the reception coil 105 which is placed in the vicinity of the object 101, and the signal detection unit 106 amplifies the received echo signal according to the command from the measurement control unit 111 to be described later, divides the signal by the quadrature phase detection into two series of signals that are orthogonal to each other, executes predetermined numbers of samplings on the respective signals (for example, 128, 256, 512, etc.), executes A/D conversion on the respective sampling signals into digital amounts, and transmits them to the signal processing unit 107 to be described later. Therefore, the echo signal is acquired as the time-series digital data (hereinafter referred to as echo data) formed by a predetermined number of sampling data.

The measurement control unit 111 transmits various commands for collecting data necessary for reconstruction of a tomographic image of the object 101 mainly to the gradient magnetic field source 109, the RF transmission unit 110 and the signal detection unit 106 so as to control them. In concrete terms, the measurement control unit 111 operates under control of the overall control unit 108 to be described later so as to control the gradient magnetic field source 109, the RF transmission unit 110 and the signal detection unit 106 based on a predetermined pulse sequence, repeatedly executes application of the RF pulse and the gradient magnetic field pulse to the object 101 and detection of the echo signal from the object 101, and collects the echo data necessary for reconstruction of an image of the object 101. In particular, the measurement control unit 111 controls the diffusion-weighted images related to the present invention.

The overall control unit 108 controls the measurement control unit 111, various data processing, display and storage of the processing results, and comprises an arithmetic processing unit having a CPU and a memory and a storage unit such as an optical disk or a magnetic disk. In concrete terms, when executing collection of echo data by controlling the measurement control unit 111 and the echo data from the signal processing unit 107 is inputted, the arithmetic processing unit executes processing such as signal processing and image reconstruction by Fourier transform and causes the storage unit to display and record the image of the object 101 which is the result of the processing on the display/operation unit 108 to be described later. In particular, the arithmetic processing unit executes calculation for reconstruction of color FA images related to the present invention.

The display/operation unit 113 is formed by a display configured to display images of the object 101 and an operation unit having a trackball or a mouse and a keyboard, etc. configured to input various control information of an MRI apparatus or control information for the processing to be executed by the overall control unit 108. This operation unit is disposed in the vicinity of the display, and an operator interactively controls various processing of the MRI apparatus via the operation unit while observing the display.

In FIG. 1, the transmission coil 104 on the transmission side and the gradient magnetic field coil 103 are disposed in a static magnetic field space of the static magnetic field generating magnet 102 into which the object 101 is inserted so as to face the object 101 if it is of the vertical magnetic field method and to surround the object 101 if it is of the horizontal magnetic field method. Also, the reception coil 105 on the reception side is disposed to face or surround the object 101.

The imaging target nuclear species of the MRI apparatus widely used in clinical sites in recent years is hydrogen nucleus (proton) which is a main constituent of the object. Shapes or functions of a body part such as a head region, abdominal region or extremities can be 2-dimensionally or 3-dimensionally imaged by reconstructing an image of the information related to spatial distribution of proton density or spatial distribution of the excited states or relaxation time.

(Acquisition of Color FA Images)

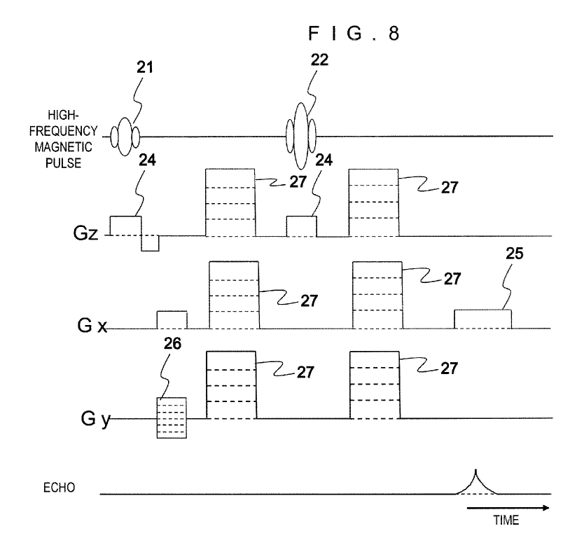

Next, general outline of the diffusion tensor method for obtaining color FA images will be described referring to FIG. 8.

FIG. 8 is a view showing an example of the pulse sequence for the diffusion tensor imaging. The measurement control unit 111 executes the following processing by controlling the above-described respective components. An RF pulse 21 is applied so that the NMR phenomenon is excited in an imaging target region. A slice gradient magnetic field 24 is applied at the time that the RF pulse is applied, and the slice in the Z-direction is selected. The magnetization intensity is inverted by applying an inverting RF pulse 22 so that an echo signal 23 is generated. Also, a readout gradient magnetic field 25 is applied in the X-direction before and after generation of the echo signal 23, and positional information of the X-direction is given to the echo signal. Also, a phase encode gradient magnetic field 26 is applied for giving positional information of the Y-direction to the echo signal so as to repeatedly change the intensity thereof for each measurement.

In order to provide information on the diffusion of water molecules, diffusion gradient magnetic fields (MPG pulses) 27 that compensate each other are respectively combined and paired to be applied between the RF pulse 21 and the inverting RF pulse 22 as well as between the inverting RF pulse 22 and the echo signal 23. The MPG pulses are provided as combination of the gradient magnetic fields in the X-direction, Y-direction and Z-direction, or individually. Application amount of the respective MPG pulses is adjusted so that time integration of the intensity in each pulse of the respective pairs turns out equal. At this time, if there is no diffusive motion of water molecule, the phase of the magnetization intensity which is dephased in the first MPG pulse is completely rephased in the second MPG pulse, and the signal intensity will not be attenuated compared to the case that a pair of MPG pulses are not applied. However, if there is diffusive motion, the signal intensity is attenuated in the rate depending on the magnitude thereof since the pulse cannot be completely rephased. Attenuation of signal intensity in an ideal case can be expressed in the equation below.

S(b)=S₀ exp(−D:b), −D:b=ΣΣDᵢⱼbᵢⱼ (1)

Here, D represents the diffusion tensor which is a symmetric matrix having 3 rows and 3 columns. b is referred to as a gradient magnetic field factor (b-factor), which can be calculated by the equation below from the application time of the MGP pulse and the application intensity.

bij=∫Y²{∫Gi(τ)dτ∫Gj(τ)dτ∫}dt (2)

The diffusion tensor can be calculated by executing one time of measurement without applying MPG pulses and at least 6 times of measurement while changing the application direction of a pair of MPG pulses so as to obtain the respective DWI images, and calculating the diffusion tensor for each pixel by equation (1) using the values of the same pixels in the plurality of DWI images.

The eigenvalues and the eigenvectors of the diffusion tensor are used for obtaining running direction of fibrous tissue. In particular, the maximum eigenvalue is referred to as a principal value, and the eigenvector corresponding to the principal value is referred to as a principal vector. The principal eigenvector indicates the direction having the highest diffusion coefficient, and matches the running direction of the fibrous tissue.

The embodiments of the MRI apparatus and the method for displaying running direction of fibrous tissue related to the present invention which converts the respective components of the eigenvector represented in a first coordinate system to a second coordinate system and obtains images showing the running direction of fibrous tissue based on the component of the eigenvector represented in the second coordinate system will be described below.

### Embodiment 1

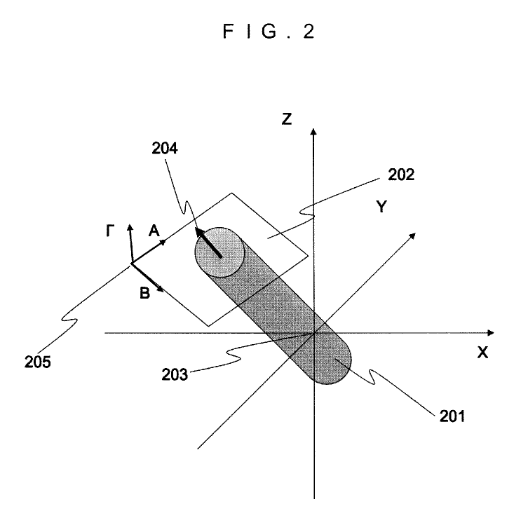

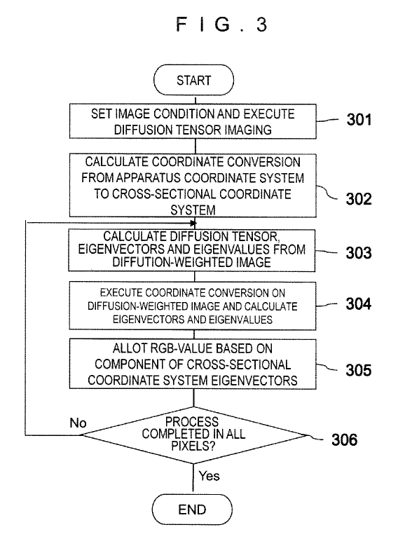

Next, the first embodiment of the MRI apparatus and the method for displaying running direction of fibrous tissue related to the present invention will be described. The present embodiment converts the respective components of the eigenvectors showing the running direction of the fibrous tissue obtained by the MRI-apparatus coordinate system (an example of a first coordinate system) to the values in the cross-sectional coordinate system (an example of a second coordinate system) obtained based on a scanned cross-section including the fibrous tissue, and obtains a color FA image in which the respective coordinate components of the eigenvector represented in the cross-sectional coordinate system are represented by the respective predetermined colors. The present embodiment will be described below based on FIG. 2 and FIG. 3.

Generally, even when an object is placed in different positions with respect to an MRI apparatus, a scanned cross-section is set with respect to the object. Therefore, by obtaining the second coordinate system representing the principal vector in accordance with the cross-section, the direction of the second coordinate system is substantially the same with respect to the running direction of a desired fibrous tissue even when the object is placed in different positions with respect to the MRI apparatus. The present invention is based on this general principle.

The general outline of the present embodiment will be described using FIG. 2. FIG. 2 is a view showing a case of imaging cross-section 202 of an object 201 which is placed in the static magnetic field space of an MRI apparatus. For the sake of explanatory convenience, the object 201 is represented as an elongated cylindrical material, assuming that the cylindrical material is configured so that water molecules are easily diffused in an axis-direction 204. The arbitrary position of the object 201 can be indicated by the apparatus coordinate system (X, Y and Z) 203 (an example of the first coordinate system). Here, the apparatus coordinate system (X, Y and Z) 203 is the coordinate system which is fixed to an MRI apparatus, and for example, the static magnetic field direction is set as the Z-axis, and the two-directions vertical to the static magnetic field direction and orthogonal to each other are respectively set as the X-direction and Y-direction. This apparatus coordinate system 203 is an invariable and fixed (a predetermined) coordinate system which does not depend on the object or the cross-section. The object 201 is placed obliquely with respect to the apparatus coordinate system 203. Also, the cross-section 202 is set, for example vertically to the axis-direction 204 of the object 201, thereby being set obliquely with respect to the apparatus coordinate system 203.

Meanwhile, a cross-sectional coordinate system 205 (an example of a second coordinate system) is obtained based on the cross-section 202. For example, the direction vertical to the cross-section 202, i.e. the slice direction is set as Γ (gamma)-direction, and two directions vertical to the Γ-direction and orthogonal to each other are respectively set as A (alpha)-direction and B (beta)-direction.

The A-direction and the B-direction can be set arbitrarily, for example the phase-encode direction can be set as the B-direction and the frequency-encode direction can be set as the A-direction.

As described above, the direction of fibrous tissue is indicated as an eigenvector (a principal vector) having the maximum eigenvalue of the diffusion tensor obtained from a diffusion-weighted image, and the component of the principal vector can be obtained by the apparatus coordinate system 203. In the present embodiment, the principal vector is indicated by the cross-sectional coordinate system 205 by converting the values of the respective coordinate components of the principal vector obtained in the apparatus coordinate system 203 to the values of the cross-sectional coordinate system 205. In concrete terms, by setting the coordinate conversion matrix from the apparatus coordinate system 203 to the cross-sectional coordinate system 205 as Ta, the principal vector in the apparatus coordinate system 203 as V and the principal vector in the cross-sectional coordinate system 205 as M (mu), the coordinate conversion can be expressed by M=Ta·V. Here, coordinate conversion matrix Ta is automatically set based on the imaging condition set by an operator before the imaging, i.e. by the slice direction, phase encode direction and the frequency encode direction. The coordinate conversion matrix Ta will be described later in detail.

Finally, a color FA image will be reconstructed by allotting respective colors of red, blue and green in accordance with the respective coordinate components (α, β, γ) of the principal vector M indicated in the cross-sectional coordinate system 205.

The present embodiment color-displays running direction of fibrous tissue as described above. That is, by obtaining a second coordinate system representing the principal vector in accordance with the oblique angle in a scanned cross-section, the color FA image in which the same fibrous tissue in a desired cross-section is displayed with the same color can be easily obtained. In other words, the second coordinate system is obtained based on a scanned cross-section in order to display the same fibrous tissue in a scanned cross-section with substantially the same aspect, and a color FA image is obtained based on the second coordinate system.

Next, operation of the present embodiment will be described in detail referring to FIG. 3. FIG. 3 is a flowchart showing the processing flow of the present embodiment. The present processing flow is stored in advance in a storage unit such as a magnetic disk as a program, and is read in to a memory by the CPU to be executed as need arises. The respective steps thereof will be described below in detail.

In step 301, the operator sets imaging conditions corresponding to the disposed position of the object 201. In concrete terms, the oblique cross-section is set by setting the slice position and the slice direction corresponding to the disposed position of the object 201 so that a desired fibrous tissue falls within the cross-section, and the phase encode direction and the frequency encode direction are set on this cross-section. As mentioned above, since the cross-section is set with respect to the object, the cross-section which is set for imaging a desired fibrous tissue is set substantially at the same position with respect to the object even when the object is placed at different positions with respect to an MRI apparatus.

When the operator initiates the diffusion tensor imaging, the measurement control unit 111 executes the DWI for the diffusion tensor imaging with respect to the specified cross-section by differentiating the application directions of the MPG pulses and measures the echo data necessary for reconstruction of a DWI image for each application direction of the MPG pulse. Then the calculation processing unit reconstructs the DWI image for each direction of the MPG pulse using the measured echo data.

In step 302, the calculation processing unit obtains coordinate conversion matrix Ta from the apparatus coordinate system 203 to the cross-sectional coordinate system 205 based on the set imaging condition, i.e. the respective direction vectors (unit vectors) of the slice direction, phase encode direction and the frequency encode direction.

In concrete terms, direction vector V_{z} in the slice direction (the vector vertical to the cross-section), direction vector V_{y} in the phase encode direction (the longitudinal direction or the horizontal direction vector in the cross-section) and direction vector Vₓ in the frequency encode direction (the horizontal direction or the longitudinal direction vector in the cross-section) are obtained from the imaging condition, and respectively represented in the apparatus coordinate system 203. Since these direction vectors are orthogonal to each other, one arbitrary vector can be calculated by the outer product of the two other remaining direction vectors. In this manner, the cross-sectional coordinate system 205 can be configured by Vₓ, V_{y} and V_{z}, and the coordinate conversion matrix Tₐ from the apparatus coordinate system 203 to the cross-sectional coordinate system 205 can be defined by equation (3) as shown below using the components of Vₓ, V_{y} and V_{z}.

$$Ta = [ \begin{matrix}{V}_{x} \\ {V}_{y} \\ {V}_{z}\end{matrix} ] \qquad ( 3 )$$

In step 303, the arithmetic processing unit calculates diffusion tensor D (3×3 matrix) using the pixel values of the same pixel position in the plurality of DWI images obtained by changing the direction of the MPG pulse, then calculates the three eigenvectors E₁, E₂ and E₃ as well as the eigenvalues λ₁, λ₂ and λ₃ from the calculated diffusion tensor (eigenvector Eᵢ corresponds to eigenvalue λᵢ).

Since the direction of the eigenvector corresponding to the maximum eigenvalue (principal value) (principal vector) can be regarded as the running direction of the fibrous tissue, when a principal value is set as λ₁, the running direction of the fibrous tissue becomes the direction of principal vector E₁ corresponding to principal value λ₁. Hereinafter, a principal value is set as λ₁, and principal vector E₁ corresponding thereto will be referred to as an apparatus coordinate system eigenvector.

In step 304, the arithmetic processing unit performs coordinate conversion matrix Tₐ obtained in step 302 on apparatus coordinate system eigenvector E₁ which is obtained in step 302, and calculates eigenvector M₁ represented in the cross-sectional coordinate system 205.

M₁=Tₐ·E₁ (4)

Hereinafter, the above-mentioned eigenvector M₁ will be referred to as a cross-sectional coordinate system eigenvector.

In step 305, the arithmetic processing unit respectively allots an RGB-value to each component (α, β, γ) of cross-sectional coordinate system eigenvector M₁ which is obtained in step 304.

In concrete terms, the arithmetic processing unit allots red-color(R) value (0˜255) in accordance with α-value, green-color(G) value (0˜255) in accordance with β-value and blue-color(B) value (0˜255) in accordance with γ-value.

In step 306, the arithmetic processing unit reconstructs a color FA image in the cross-sectional coordinate system 205 by performing calculations and processes in the above-described step 303˜step 305 for the same pixel in each of the respective DWI images.

The processing flow of the present embodiment has been described above. Based on the above-described processing flow, the arithmetic processing unit obtains the cross-sectional coordinate system in accordance with the oblique angle of the cross-section so that the same fibrous tissue in the cross-section can be displayed substantially in the same aspect, and reconstructs a color FA image based on the obtained cross-sectional coordinate system.

As described above, in accordance with the MRI apparatus and the method for displaying the running direction of fibrous tissue in the present embodiment, the eigenvector representing the running direction of fibrous tissue obtained by the apparatus coordinate system is converted to the eigenvector in the cross-sectional coordinate system obtained in accordance with the cross-section which is set corresponding to the disposed position of an object, and coloring of the pixels is executed based on the respective coordinate components of the eigenvector represented in the cross-sectional coordinate system. As a result, color FA images in which the same fibrous tissue is displayed by the same color can easily obtained without executing complex 3-dimensional processing but with only simple coordinate conversion processing, even when the object is imaged in different positions with respect to an MRI apparatus.

### Embodiment 2

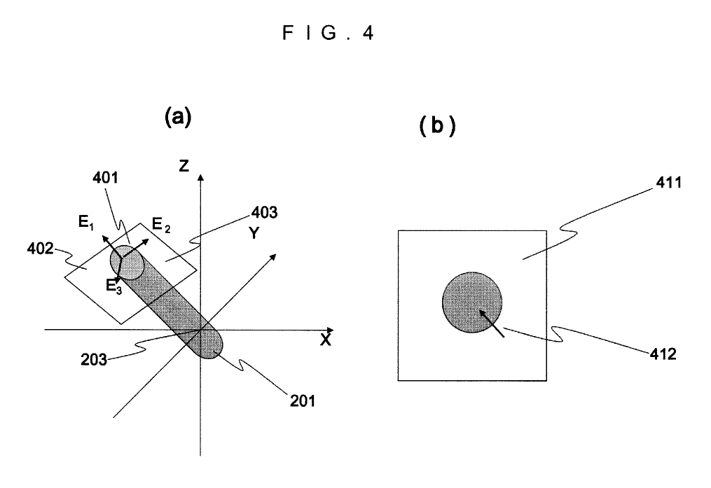

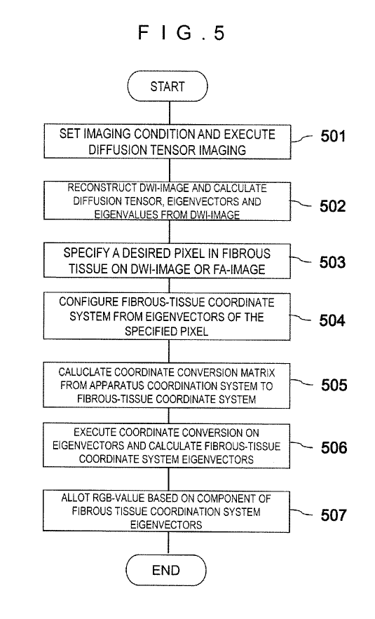

Next, the second embodiment of the MRI apparatus and the method for displaying running direction of fibrous tissue related to the present invention will be described. The present embodiment sets and obtains the coordinate system formed by the eigenvectors with respect to the pixel specified on a set cross-sectional image as a fibrous-tissue coordinate system (a second coordinate system). Then the eigenvectors obtained by the apparatus coordinate system (an example of the first coordinate system) are converted to the fibrous-tissue coordinate system, and the respective coordinate components of the eigenvectors represented in the fibrous-tissue coordinate system are displayed by the respective predetermined colors in a color FA image to be obtained. The difference of the present embodiment from the first embodiment will be described below referring to FIGS. 4 and 5, and the duplicative descriptions will be omitted.

First, general outline of the present embodiment will be described based on FIG. 4. FIG. 4(a) is a view showing the case of imaging a cross-section 402 of the object 201 placed in a static magnetic field space of an MRI apparatus. Also, FIG. 4(b) shows an image 411 which is selected from among a plurality of DWI images obtained by imaging the cross-section 402 or the FA images reconstructed based on the DWI image data and displayed on the display.

Diffusion tensor imaging is executed by a set imaging condition, and the eigenvectors in the apparatus coordinate system (X, Y, Z) 203 (first coordinate system) and the FA image is obtained. Then a desired pixel is specified on the image 411 which is arbitrarily selected from among the plurality of DWI images or the FA images.

Next, a coordinate system is configured using three eigenvectors E₁, E₂ and E₃ in the specified pixel. Thee eigenvectors E₁, E₂ and E₃ are orthogonal to each other, wherein the eigenvector corresponding to the maximum eigenvector thereof represents the running direction of the fibrous tissue in the pixel and the other two eigenvectors are orthogonal to the running direction of the fibrous tissue and also to each other. Therefore, the coordinate system having these three eigenvectors E₁, E₂ and E₃ as its axes can be easily configured, and such configured coordinate system is referred to as a fibrous-tissue coordinate system 401 (second coordinate system) in the present embodiment. Any one of these axes in such configured fibrous-tissue coordinate system 401 is parallel to the running direction of the fibrous tissue in the specified pixel. As a result, regardless of the disposed position of the object with respect to an MRI apparatus, it is possible to configure substantially the same coordinate system corresponding to the running direction of the fibrous tissue in the specified pixel.

Finally, three eigenvectors represented by the apparatus coordinate system in the other pixels are converted to the fibrous-tissue coordinate system 401. Then coloring of the other pixels is executed by respectively allotting an RGB-value to the coordinate components of the eigenvectors indicated in the fibrous-tissue coordinate system. A color FA image can be obtained by repeating coordinate conversion of the eigenvectors indicated in the apparatus coordinate system to the fibrous-tissue coordinate system 401 and allotment of an RGB value to the respective coordinate components of the eigenvectors indicated by the fibrous-tissue coordinate system 401 in all other pixels.

In the present embodiment, the second coordinate system is obtained so as to display the fibrous tissue running with a predetermined angle with respect to a scanned cross-section of an image including a specified pixel in substantially the same aspect, and color a FA image is obtained based on this second coordinate system. In this manner, since the reconstructed color FA image is colored by the coordinate system on the basis of a desired position fibrous tissue, it is possible to display not only fibrous tissue in a specified pixel but also the fibrous tissue having the same running direction with the same color.

Next, operation of the present embodiment will be described in detail using FIG. 5. FIG. 5 is a flowchart showing processing flow of the present embodiment. The present processing flow is stored as a program in advance in the storage unit such as a magnetic disk, to be read in to a memory as need arises and executed by the CPU. The respective steps will be described below in detail.

In step 501, the operator sets the imaging condition corresponding to a disposed position of the object 201. Next, the measurement control unit 111 executes the diffusion tensor imaging with respect to a specified oblique cross-section based on the set imaging condition. The concrete content will be omitted here since it is the same as the aforementioned step 301.

In step 502, the arithmetic processing unit reconstructs an DWI image for each MPG pulse direction using the echo data measured in step 501. Then arithmetic processing unit calculates the diffusion tensor for each pixel in the apparatus coordinate system (X, Y, Z) 203 using the plurality of DWI images, and obtains an FA image by obtaining the three eigenvalues and eigenvectors.

In step 503, the operator selects the image 411 from among the plurality of DWI images or FA images obtained in step 502, and causes the selected image to be displayed on the display. Then the operator specifies a desired pixel from any of the fibrous tissue depicted on the selected image 411 using a pointer 412 (pixel specifying UI (User Interface)) which can be freely moved on the image 411 via an operation unit such as a trackball or a mouse and a keyboard.

In step 504, the arithmetic processing unit configures the fibrous-tissue coordinate system having three eigenvectors E₁, E₂ and E₃ as its axes in the pixel specified in step 503. At this time, by setting for example the eigenvector corresponding to the maximum eigenvalue (here, E₃) as the Z-axis and the remaining eigenvectors E₁ and E₂ as the Y-axis and the X-axis, a fibrous-tissue coordinate system (E₁, E₂, E₃) 401 is configured. The method for allotting eigenvectors to a coordinate system is not limited to the above-described one, thereby correspondence between (E₁, E₂, E₃) and (X-axis, Y-axis, Z-axis) can be arbitrarily performed.

In step 505, the arithmetic processing unit obtains coordinate conversion matrix T_{b} for converting the eigenvectors in the respective pixels indicated in the apparatus coordinate system (X, Y, Z) 203 to the fibrous-tissue coordinate system (E₁, E₂, E₃) 401 obtained in step 504. The coordinate conversion matrix T_{b} from the apparatus coordinate system 203 to the fibrous-tissue coordinate system 401 can be defined as equation (5) as in equation (2) using the components of three eigenvectors E₁, E₂ and E₃.

$$Tb = [ \begin{matrix}{E}_{1} \\ {E}_{2} \\ {E}_{3}\end{matrix} ] \qquad ( 5 )$$

In step 506, the arithmetic processing unit converts and indicates the eigenvectors in the respective pixels indicated in the apparatus coordinate system (X, Y, Z) 203 obtained in step 502 to the fibrous-tissue coordinate system (E₁, E₂, E₃) 401 obtained in step 504 using the coordinate conversion matrix T_{b} obtained in step 505. The coordinate conversion from the eigenvector E of the apparatus coordinate system 203 to the eigenvector M indicated in the fibrous-tissue coordinate system 401 can be executed using equation (6) as in the same manner in equation (3).

M=T_{b}·E (6)

In step 507, the arithmetic processing unit respectively allots an RGB-value to the respective coordinate components of the eigenvectors in the respective pixels indicated in the fibrous-tissue coordinate system obtained in step 506. In this manner, a color FA image represented by the fibrous-tissue coordinate system 401 specified in step 503 can be obtained.

The processing flow of the present embodiment has been described above.

As mentioned above, the MRI apparatus or the method for displaying running direction of fibrous tissue related to the present embodiment configures a fibrous-tissue coordinate system based on the eigenvectors in a desired pixel in the fibrous tissue which is specified on the image of the cross-section set while being corresponded to the disposed position of the object. Then the eigenvectors in the respective pixels indicated by the apparatus coordinate system are converted to the configured fibrous-tissue coordinate system. Finally, an FA color image is reconstructed by respectively allotting the RGB-value to the respective coordinate components of the eigenvectors indicated by the fibrous-tissue coordinate system. As a result, it is possible to color the fibrous tissue in the other pixels on the basis of the running direction of the fibrous tissue in a desired pixel. Therefore, it is possible to easily obtain color FA images in which the desired fibrous tissue can have the same color without a complex 3-dimensional processing but only with simple coordinate conversion processing, even when an object is imaged at different positions with respect to an MRI apparatus.

### Embodiment 3

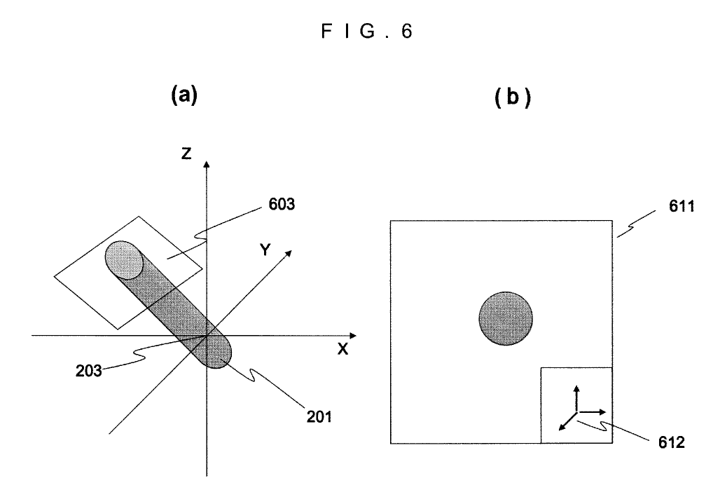

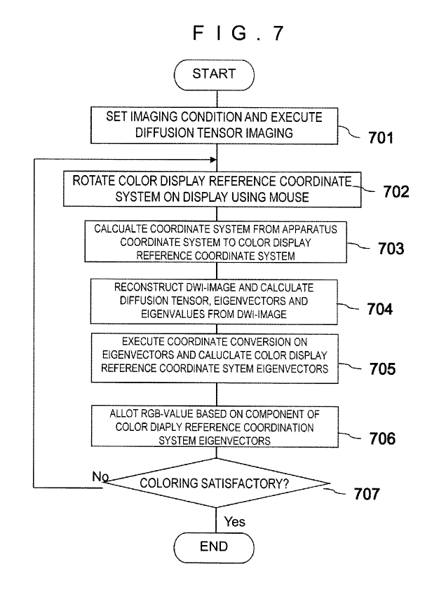

Next, the third embodiment of the MRI apparatus and the method for displaying running direction of fibrous tissue related to the present invention will be described. The present embodiment comprises a coordinate system rotation UI (User Interface) which enables an operator to arbitrarily rotate and set the coordinate system to be the basis for color FA image display. Then a color display reference coordinate system (an example of the second coordinate system) is obtained according to the rotating angle set by the operator using the coordinate system rotation UI, the respective components of the eigenvector indicating the running direction of the fibrous tissue obtained by the MRI apparatus coordinate system (an example of the first coordinate system) is converted to the color display reference coordinate system, and a color FA image is reconstructed based on the color display reference coordinate system. The difference from the above-described embodiments will be described referring to FIGS. 6 and 7, and the duplicative description thereof will be omitted.

First, the general outline of the present embodiment will be described based on FIG. 6. FIG. 6(a) is a view showing the case of imaging a cross-section 603 of the object 201 placed in a static magnetic field space of an MRI apparatus. Also, FIG. 6(b) shows a DWI image or an FA image 611, and color display reference coordinate system 612 (second coordinate system) to be the reference coordinate system for reconstructing a color FA image which are displayed on the display.

The operator rotates this color display reference coordinate system 612 at a desired angle via an operation unit such as a trackball or a mouse and a keyboard. Then the operator converts the eigenvector (principal vector) having the maximum eigenvector calculated in the apparatus coordinate system (first coordinate system) to the rotated color display reference coordinate system 612 for each pixel of the DWI image or FA image, and obtains the eigenvectors represented in the color display reference coordinate system 612.

Finally, the operator reconstructs a color FA image by coloring it according to the value of the respective coordinate components in the eigenvectors represented by the color display reference coordinate system 612. The operator repeats confirmation of the color FA images displayed on the display while rotating the color display reference coordinate system 602 until a desired color FA image is obtained.

To summarize the above, the present embodiment obtains a second coordinate system so that the fibrous tissue that is parallel to one of the axes of the set coordinate system can be displayed in substantially the same aspect, and obtains a color FA image based on the second coordinate system. In this way, it is possible to obtain color FA images in which desired tissue is displayed with substantially the same color without being influenced by disposed positions of an object. In other words, it is possible to obtain color FA images in which desired fibrous tissue is colored with substantially the same color without being influenced by variation in running directions of the fibrous tissue which is dependent on the disposed positions of the object with respect to the MRI apparatus.

Next, operation of the present embodiment will be described in detail referring to FIG. 7. FIG. 7 is a flowchart showing a processing flow of the present embodiment. The present processing flow is stored as a program in advance in a storage unit such as a magnetic disk, and carried out by read in and executed by the CPU as need arises. The respective steps of the embodiment will be described below in detail.

In step 701, the operator sets imaging conditions corresponding to the disposed position of the object 201. Next, the measurement control unit 111 executes the diffusion tensor imaging with respect to a specified oblique cross-section based on the set imaging condition. The detailed descriptions thereof will be omitted since they are the same as the above-described steps 301 and 501.

In step 702, the operator rotates the color display reference coordinate system 612 displayed on the display via an operation unit such as a trackball or a mouse and a keyboard, and sets it at a desired angle. At this time, the initial position of the color display reference coordinate system 612 is set at the same as the apparatus coordinate system or at the previously set position. When the operator rotates the color display reference coordinate system 602 via the operation unit, the arithmetic processing unit calculates the rotation amount of the color display reference coordinate system 612 in accordance with the operation amount of the trackball, mouse or keyboard, executes rotation setting of the color display reference coordinate system 612 based on the calculated rotation amount, and causes the rotated color display reference coordinate system 612 to be displayed on the display.

In concrete terms, the unit vectors for configuring the color display reference coordinate system 612 before rotation operation are set as E₁, E₂ and E₃. The components of these unit vectors are represented by the apparatus coordinate system, which can be represented as, for example E₁=(1, 0, 0), E₂=(0, 1, 0) , E₃=(0, 0, 1) if they are the same as the unit vectors which configure the apparatus coordinate system. In accordance with the rotation amount of the color display reference coordinate system 612, the arithmetic processing unit rotates the unit vectors E₁, E₂ and E₃ and sets the coordinate system configured by unit vectors Σ₁, Σ₂ and Σ₃ after rotation as the color display reference coordinate system 612 after rotation.

In step 703, the arithmetic processing unit calculates the coordinate conversion matrix from the apparatus coordinate system to the color display reference coordinate system set in step 702. Coordinate conversion matrix T_{c} can be defined as equation (7) by the components of eigenvectors Σ₁, Σ₂ and Σ₃ which configure the color display reference coordinate system 612 after rotation obtained in step 702.

$$Tc = [ \begin{matrix}{Σ}_{1} \\ {Σ}_{2} \\ {Σ}_{3}\end{matrix} ] \qquad ( 7 )$$

In step 704, the arithmetic processing unit reconstructs a DWI image for each direction of the MGP pulse using the echo data measured in step 701. Then the arithmetic processing unit calculates the diffusion tensor for each pixel in the apparatus coordinate system (X, Y, Z) 203 using the plurality of DWI images, and obtains an FA image by obtaining three eigenvalues and eigenvectors.

In step 705, the arithmetic processing unit executes coordinate conversion on the principal vector of the respective pixels indicated by the apparatus coordinate system (X, Y, Z) 203 obtained in step 704 to the color display reference coordinate system 612 set in step 702 using coordinate conversion matrix T_{c} obtained in step 703. The coordinate conversion from the principal vector E of the apparatus coordinate system 203 to the principal vector M indicated in the color display reference coordinate system 612 can be executed by using equation (8) as in equations (3) and (5).

M=T_{c}·E (8)

In step 706, the arithmetic processing unit respectively allots an RGB-value to the respective coordinate components of the principal vector in the respective pixels indicated by the color display reference coordinate system 612 set in step 702. In this manner, color FA images represented by the color display reference coordinate system 612 set in step 702 can be obtained.

In step 707, the operator completes the present processing flow in the case that coloring of the color FA image obtained in step 706 is satisfactory, and returns to step 702 again to reset the color display reference coordinate system 612 if the coloring is not satisfactory.

The processing flow of the present embodiment has been described above.

As described above, the MRI apparatus and the method for display running direction of fibrous tissue related to the present embodiment comprises the coordinate system rotation UI in which an operator can arbitrarily set the reference coordinate system for color display. Then the eigenvector indicating the running direction of the fibrous tissue obtained by the apparatus coordinate system is converted to the color display reference coordinate system set by the operator. Then a color FA image is reconstructed by respectively allotting an RGB-value to the respective coordinate components of the eigenvectors indicated in the color display reference coordinate system.

As a result, fibrous tissue can be colored as desired without being influenced by different positions of the object with respect to an MRI apparatus. Therefore, it is possible to easily obtain color FA images in which desired fibrous tissue can be displayed with the same color without complex 3-dimensional processing but with only simple coordinate conversion, even when the object is disposed at different positions with respect to the MRI apparatus at the time of imaging.

The respective embodiments of the MRI apparatus and the method for displaying running direction of fibrous tissue related to the present invention has been described above. However, the present invention is not limited to these embodiments, and various kinds of alterations or modifications can be made within the scope of the technical idea disclosed in this application.

For example, the respective embodiments may be combined. Or, one or both of the second embodiment and the third embodiment may be carried out after executing the first embodiment.

In addition, the present invention described in the entire embodiments may be applied to any fibrous tissue in cranial nerves, a trunk of body or extremities.

### DESCRIPTION OF REFERENCE NUMERALS

1: object

2: static magnetic field generating system

3: gradient magnetic field generating system

4: sequencer

5: transmission system

6: reception system

7: signal processing system

8: central processing unit (CPU)

9: gradient magnetic field coil

10: gradient magnetic field source

11: high-frequency oscillator

12: modulator

13: high-frequency amplifier

14a: high-frequency coil (transmission coil)

14b: high-frequency coil (reception coil)

15: signal amplifier

16: quadrature phase detector

17: A/D converter

18: magnetic disk

19: optical disk

20: display

21: ROM

22: RAM

23: trackball or mouse

24: keyboard

25: operation unit

26: object

27: scanned cross-section

28: apparatus coordinate system

29: axis-direction of circular cylinder

30: FA image

31: mouse pointer

32 apparatus coordinate system

33: fibrous-tissue coordinate system

34: FA image

35: reference coordinate system setting screen

1. A magnetic resonance imaging apparatus comprising:
an imaging unit configured to apply a diffusion-weighted gradient magnetic field to a region including fibrous tissue in an object to be examined and acquire plural sets of diffusion-weighted image data with respect to a cross-section including the fibrous tissue; and
an arithmetic processing unit configured to construct a diffusion tensor using plural sets of diffusion-weighted image data, calculate eigenvectors represented in a predetermined first coordinate system from the diffusion tensor, and obtain an image showing the running direction of the fibrous tissue based on the calculated eigenvectors,
wherein the arithmetic processing unit converts the respective components of the eigenvectors represented in the predetermined first coordinate system to a second coordinate system, and obtains an image showing the running direction of the fibrous tissue based on the components of eigenvectors represented in the second coordinate system.

2. The magnetic resonance imaging apparatus according to claim 1, wherein:
the cross-section is set oblique with respect to the first coordinate system; and
the arithmetic processing unit obtains the second coordinate system based on the cross-section.

3. The magnetic resonance imaging apparatus according to claim 2, wherein the arithmetic processing unit sets the second coordinate system so that the direction of a normal line in the scanned cross-section becomes one axis in the second coordinate system.

4. The magnetic resonance imaging apparatus according to claim 2, wherein the arithmetic processing unit sets the coordinate system having the slice direction, the phase encode direction and the frequency encode direction respectively as the coordinate axes as the second coordinate system.

5. The magnetic resonance imaging apparatus according to claim 2, wherein the arithmetic processing unit obtains the second coordinate system in accordance with the oblique angle so that the fibrous tissue in the scanned cross-section can be displayed in substantially the same aspect.

6. The magnetic resonance imaging apparatus according to claim 1, characterized in comprising a pixel specifying UI configured to receive specification of a desired pixel in the image obtained by imaging the cross-section, wherein the arithmetic processing unit obtains the second coordinate system based on the eigenvectors with respect to the pixel which is specified via the pixel specifying UI.

7. The magnetic resonance imaging apparatus according to claim 6, wherein the arithmetic processing unit obtains the second coordinate system, in the pixel specified via the pixel specifying UI, so that the fibrous tissue running at a predetermined angle with respect to the cross-section of the image including the specified pixel is displayed in substantially the same aspect.

8. The magnetic resonance imaging apparatus according to claim 1, characterized in comprising a coordinate system rotation UI configured to receive operation to rotate a coordinate system, wherein the arithmetic processing unit obtains the second coordinate system in accordance with the rotating angle of the coordinate system set via the coordinate system rotation UI.

9. The magnetic resonance imaging apparatus according to claim 8, wherein the arithmetic processing unit obtains the second coordinate system for each setting of a rotating angle of the coordinate system via the coordinate system rotation UI, converts the component of the principal vector to the rotated second coordinate system, and obtains the image showing the running direction of the fibrous tissue based on the component of the converted eigenvector.

10. The magnetic resonance imaging apparatus according to claim 8, wherein the arithmetic processing unit obtains the second coordinate system so that the fibrous tissue which is parallel to one axis of the coordinate system set by the coordinate system rotation UI is displayed in substantially the same aspect.

11. The magnetic resonance imaging apparatus according to claim 1, wherein the arithmetic processing unit allots a predetermined color to each component of the eigenvector executed with coordinate conversion and obtains the image in which the running direction of the fibrous tissue is color-displayed.

12. A method for displaying running direction of fibrous tissue that configures a diffusion tensor using plural sets of diffusion-weighted image data acquired by imaging a region including fibrous tissue of an object to be examined, calculates eigenvectors represented by a predetermined first coordinate system from the diffusion tensor, and displays an image showing the running direction of the fibrous tissue based on the calculated eigenvectors, having:
a step of obtaining a second coordinate system;
a step of representing the components of eigenvectors represented in the predetermined first coordinate system to the second coordinate system, and
a step of obtaining an image showing the running direction of the fibrous tissue based on the components of eigenvectors represented in the second coordinate system.

13. The method for displaying running direction of fibrous tissue according to claim 12, wherein the step of obtaining the second coordinate system obtains the second coordinate system based on the scanned cross-section which is set oblique with respect to the first coordinate system.

14. The method for displaying running direction of fibrous tissue according to claim 12, characterized in comprising a step of receiving specification of a desired pixel in the image obtained by scanning a cross-section, wherein the step of obtaining the second coordinate system obtains the eigenvectors from the diffusion tensor with respect to the specified pixel, and obtains the second coordinate system based on the eigenvectors of the specified pixel.

15. The method for displaying running direction of fibrous tissue according to claim 12, characterized in comprising a step of receiving operation to rotate a coordinate system, wherein the step of obtaining the second coordinate system obtains the second coordinate system in accordance with the rotating angle of the coordinate system.
